(19) United States
(12) Patent Application Publication
(10) Pub. No.: US 2007/0077891 A1
(43) Pub. Date: Apr. 5, 2007

(54) Apparatus and method treating received communication signals

(75) Inventor: David Johnston, Beaverton, OR (US)

Correspondence Address: Law Office of Donald D. Mondul;c/o PortfolioIP, P.O. Box 52050, Minneapolis, MN, 55402, US

(73) Assignee: Intel Corporation

(21) Appl. No.: 11/241,626

(22) Filed: Sep. 30, 2005

(51) Int. Cl. H04B 17/00

(52) U.S. Cl. 455/67.11

(57) ABSTRACT

An apparatus treating communication signals in a communication environment includes: (a) a plurality of processing elements coupled for effecting the treating; (b) a first subset of processing elements of the plurality of processing elements cooperating to effect a first the treating of the communication signals communicated in a first communication network in the communication environment; and (c) a second subset of processing elements of the plurality of processing elements cooperating to identify signals of a second communication network in the communication environment among the communication signals.

### BACKGROUND

In mobile wireless communication operations it is sometimes necessary to change to a new access point, such as a mobile telephone cellular tower, to keep a viable and useful communication link established in order to continue reliably communicating. The process of changing to a new access point in a communication system is sometimes referred to as “handoff” or “handover”. In a handover operation, a mobile communication unit may begin to communicate with a second communication access point and discontinue communicating with a first communication access point.

Presently, a mobile communication unit periodically ceases communicating to effect a survey or review of its communication environment to ascertain whether a second communication access point is available for handover. Such a ceasing of communication to ascertain whether another access point is available for handover is disruptive and inefficient.

There is a need for an efficient apparatus and method by which a mobile communication unit may ascertain whether a communication access point is available for handover without disrupting communication operations.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram representing an apparatus for treating communication signals during normal communication operation;

FIG. 2 is a schematic diagram representing an apparatus for treating communication signals while configured for identifying an alternate access point for a handover operation; and

FIG. 3 is a flow diagram illustrating the method of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows may be presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

Types of cellular radiotelephone communication systems intended to be within the scope of the present invention include, although not limited to, Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like.

The apparatus of the present invention may be embodied in a reconfigurable communication array (RCA). An RCA may be embodied in a platform for dynamic reconfigurable computing in support of communication operations. In one configuration an RCA may include a fine-grained array of reconfigurable logic “tiles”. Each tile may be programmed to perform a wide variety of functions, and respective tiles may be communicatively coupled within the RCA. Each tile may be viewed as a processing element and an associated routing element. Tiles are not necessarily uniform in nature and tiles in the same array may differ from each other in size, function and capability

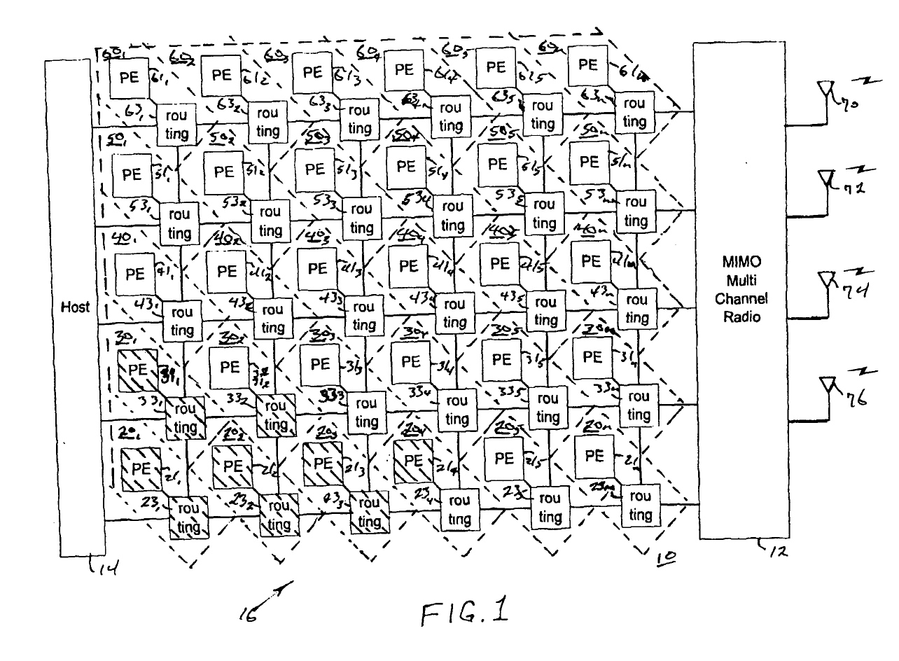

FIG. 1 is a schematic diagram representing an apparatus for treating communication signals during normal communication operation. In FIG. 1, a communication system 10 may include a communication transceiver unit 12 and a host unit 14 coupled by a reconfigurable communication array (RCA) 16. Communication transceiver unit 12 may be configured as a MIMO (Multiple Input-Multiple Output) radio unit. A MIMO radio unit may employ multiple antennas 70, 72, 74, 76 for communicating multiple signals substantially simultaneously. Four antennas is a representative number only; transceiver unit 12 may contain any number of antennas.

Host unit 14 may establish an interface between communication transceiver unit 12 and a human operator or other equipment appropriate for effecting further handling of signals (not shown in FIG. 1).

RCA unit 16 may treat signals from host unit 14 to present treated signals for transmission by transceiver unit 12. RCA unit 16 also may treat signals from transceiver unit 12 to present treated signals to host unit 14 for use elsewhere such as a human operator or other equipment appropriate for effecting further handling of signals (not shown in FIG. 1). RCA unit 16 may include a plurality of processing elements, by way of example and not by way of limitation: a first row of processing elements 20₁, 20₂, 20₃, 20₄, 20₅, 20ₙ; a second row of processing elements 30₁, 30₂, 30₃, 30₄, 30₅, 30ₙ; a third row of processing elements 40₁, 40₂, 40₃, 40₄, 40₅, 40ₙ; a fourth row of processing elements 50₁, 50₂, 50₃, 50₄, 50₅, 50ₙ; and a fifth row of processing elements 60₁, 60₂, 60₃, 60₄, 60₅, 60ₙ. Six rows of processing units is a representative number only; RCA unit 16 may contain any number of processing units, and those processing elements may be connected in any topology, including by way of example and not by way of limitation polar arrangements, spherical arrangements and other two-dimensional or three-dimensional arrangements. The indicator “n” is employed to signify that there can be any number of processing elements in a row in RCA unit 16. The inclusion of six processing elements in FIG. 1 is illustrative only and does not constitute any limitation regarding the number of processing elements that may be included in RCA unit 16 of the present invention. RCA unit 16 may be embodied in various configurations, such as a network interface card (NIC).

For simplicity, respective processing and associated units or elements will be referred to using a subscript “n” notation to indicate any one of such a processing unit or associated unit or element. Each respective processing unit 20ₙ, 30ₙ, 40ₙ, 50ₙ, 60ₙ may include a respective processor element 21ₙ, 31ₙ, 41ₙ, 51ₙ, 61ₙ and a respective routing unit 23ₙ, 33ₙ, 43ₙ, 53ₙ, 63ₙ. Routing units 23ₙ, 33ₙ, 43ₙ, 53ₙ, 63ₙ may be interconnected to permit cooperative participation by processor elements 21ₙ, 31ₙ, 41ₙ, 51ₙ, 61ₙ for configuring RCA unit 16 to effect various communication tasks.

The array of flexible interconnected processing units 20ₙ, 30ₙ, 40ₙ, 50ₙ, 60ₙ may permit apparatus 10 to be programmed to support a variety of protocols in a variety of communication networks in a communication environment. Generally, in prior art communication apparatuses using RCA units, resources available (i.e., processing units 20ₙ, 30ₙ, 40ₙ, 50ₙ, 60ₙ) are configured as required to support a single standard or single communication network. Such a limited-applicability design approach holds down cost by avoiding addition of logic that would be necessary to support another standard.

In a system that is designed to support different protocols, networks or standards that do not often employ identical or easily shared resources, there are often some unused resources in a given network interface card (NIC) or other embodiment of RCA unit 16. By way of example and not by way of limitation, processing units 20₁, 20₂, 20₃, 20₄, 30₁ are cross-hatched in FIG. 1 to indicate those processing units 20₁, 20₂, 20₃, 20₄, 30₁ as unused while communication system 10 is communicating with a first network using four antennas 70, 72, 74, 76 in a MIMO configuration.

Reconfiguring an NIC or other embodiment of a reconfigurable communications array (RCA) to employ at least some otherwise unused resources is an efficient approach. By reducing capacity in a MIMO system to operate using fewer antennas, by way of example and not by way of limitation using three antennas rather than four antennas, one may free up resources in an NIC to use with otherwise idle resources to perform other tasks than handling extant communications with a particular protocol, network or standard. Reducing the number of antennas for handling extant communications may reduce capacity of communication system 10 somewhat, but it may be preferable to reduce system capacity rather than to substantially entirely shut down communication capability while identifying other networks for handover and similar operations. Such a substantial shutting down of communication capability while identifying other networks for handover and similar operations is often required in prior art systems.

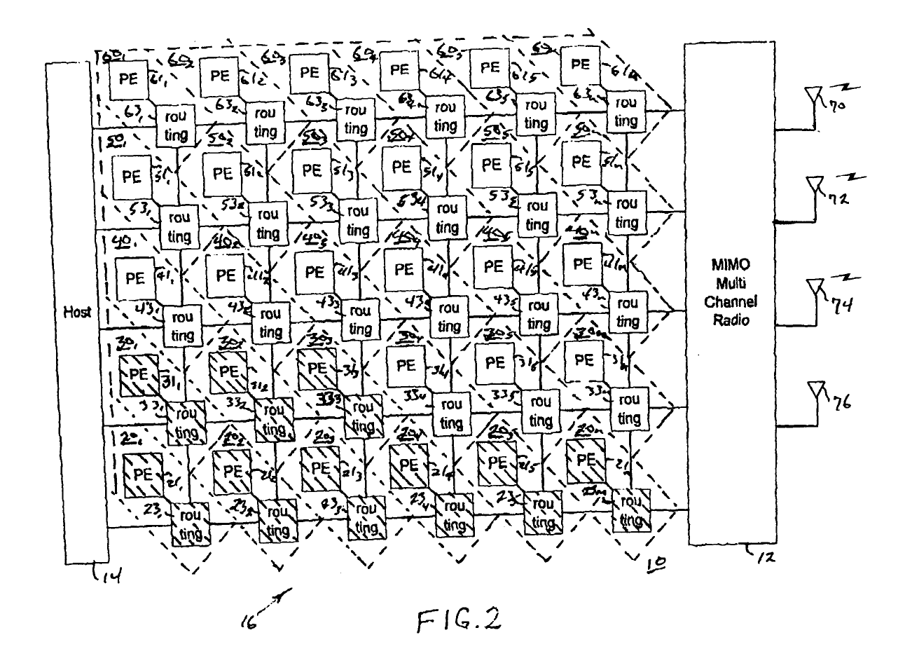

FIG. 2 is a schematic diagram representing an apparatus for treating communication signals while configured for identifying an alternate access point for a handover operation. Elements in FIG. 2 that are similar to elements described in connection with FIG. 1 are identified using similar reference numerals to numerals employed in FIG. 1. In the interest of avoiding prolixity, only differences between FIG. 1 and FIG. 2 will be addressed when describing FIG. 2.

RCA 16 is reconfigured in FIG. 2 vis-à-vis FIG. 1 in that antenna 76 is not participating in operation of transceiver unit 12. Reducing a requirement for communication system 10 to support one less antenna (i.e., antenna 76) may free up some resources in RCA 16 to perform other tasks than handle extant communications in a first communication network. Additional resources may be teamed with previously idle resources to increase efficiency of communication system 10 in identifying signals in a second communication network. Once a second network is identified, the additional and previously idle resources may be employed to evaluate the second network signals regarding whether the second network signals are appropriate for a handover operation.

By way of example and not by way of limitation, processing units 20₅, 20ₙ, 30₂, 30₃are cross-hatched in FIG. 2 to indicate those processing units 20₅, 20ₙ, 30₂, 30₃as being available for use along with previously unused processing units 20₁, 20₂, 20₃, 20₄, 30₁, (FIG. 1). By using one less antenna for MIMO operations by transceiver 12, processing units 20₁, 20₂, 20₃, 20₄, 20₅, 20ₙ, 30₁, 30₂, 30₃ are available for use in identifying and, if desired, evaluating, other communication signals in networks other than the extant first network handled by communication system 10 while communication system 10 is communicating in the first network using three antennas 70, 72, 74 in a MIMO configuration.

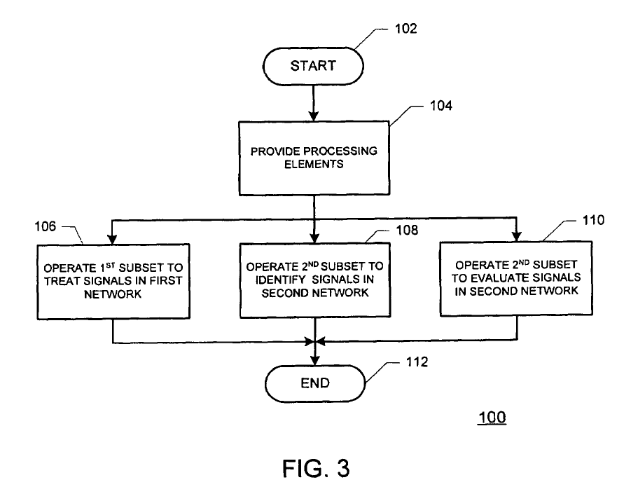

FIG. 3 is a flow diagram illustrating the method of the present invention. In FIG. 3, a method 100 treating communication signals in a communication environment begins at a START locus 102. Method 100 may continue by providing a plurality of processing elements coupled for effecting the treating, as indicated by a block 104. Method 100 may continue by, in no particular order: (1) operating a first subset of processing elements of the plurality of processing elements to effect a first treating of the communication signals communicated in a first communication network in the communication environment, as indicated by a block 106; and (2) operating a second subset of processing elements of the plurality of processing elements to identify signals of a second communication network in the communication environment among the communication signals, as indicated by a block 108. If desired, method 100 may also operate the second subset processing elements to evaluate the signals of the second communication network for a handover opportunity for the system, as indicated by a block 110. Method 100 terminates at an END block 112.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system effecting communications in a communication environment; the system comprising:
(a) a transceiver unit for handling communication signals in said communication environment;
(b) a plurality of communication processing elements coupled with said transceiver unit for treating said communication signals to present treated communication signals;
(c) a host unit coupled with said plurality of communication processing elements for processing said treated communication signals;
(d) a first subset of communication processing elements of said plurality of communication processing elements cooperating to effect a first said treating of said communication signals communicated in a first communication network in said communication environment; and
(e) a second subset of communication processing elements of said plurality of communication processing elements cooperating to identify signals of a second communication network in said communication environment among said communication signals.

2. A system effecting communications in a communication environment as recited in claim 1 wherein said first subset and said second subset are mutually exclusive subsets.

3. A system effecting communications in a communication environment as recited in claim 1 wherein at least one selected said processing element of said first subset and selected elements of said second subset is a common element to both said first subset and said second subset; said at least one common element being employed in a time-share manner in said first subset and in said second subset.

4. A system effecting communications in a communication environment as recited in claim 1 wherein said second subset effects evaluation of said signals of said second communication network for a handover opportunity for the system.

5. A system effecting communications in a communication environment as recited in claim 2 wherein said second subset effects evaluation of said signals of said second communication network for a handover opportunity for the system.

6. A system effecting communications in a communication environment as recited in claim 3 wherein said second subset effects evaluation of said signals of said second communication network for a handover opportunity for the system.

7. An apparatus treating communication signals in a communication environment; the apparatus comprising:
(a) a plurality of processing elements coupled for effecting said treating;
(b) a first subset of processing elements of said plurality of processing elements cooperating to effect a first said treating of said communication signals communicated in a first communication network in said communication environment; and
(c) a second subset of processing elements of said plurality of processing elements cooperating to identify signals of a second communication network in said communication environment among said communication signals.

8. An apparatus treating communication signals in a communication environment as recited in claim 7 wherein said first subset and said second subset are mutually exclusive subsets.

9. An apparatus treating communication signals in a communication environment as recited in claim 7 wherein at least one selected said processing element of said first subset and selected elements of said second subset is a common element to both said first subset and said second subset; said at least one common element being employed in a time-share manner in said first subset and in said second subset.

10. An apparatus treating communication signals in a communication environment as recited in claim 7 wherein said second subset effects evaluation of said signals of said second communication network for a handover opportunity for the system.

11. An apparatus treating communication signals in a communication environment as recited in claim 8 wherein said second subset effects evaluation of said signals of said second communication network for a handover opportunity for the system.

12. An apparatus treating communication signals in a communication environment as recited in claim 9 wherein said second subset effects evaluation of said signals of said second communication network for a handover opportunity for the system.

13. A method treating communication signals in a communication environment; the method comprising:
(a) providing a plurality of processing elements coupled for effecting said treating; and
(b) in no particular order:
(1) operating a first subset of processing elements of said plurality of processing elements to effect a first said treating of said communication signals communicated in a first communication network in said communication environment; and
(2) operating a second subset of processing elements of said plurality of processing elements to identify signals of a second communication network in said communication environment among said communication signals.

14. A method treating communication signals in a communication environment as recited in claim 13 wherein said first subset and said second subset are mutually exclusive subsets.

15. A method treating communication signals in a communication environment as recited in claim 13 wherein at least one selected said processing element of said first subset and selected elements of said second subset is a common element to both said first subset and said second subset; said at least one common element being employed in a time-share manner in said first subset and in said second subset.

16. A method treating communication signals in a communication environment as recited in claim 13 wherein said second subset effects evaluation of said signals of said second communication network for a handover opportunity for the system.

17. A method treating communication signals in a communication environment as recited in claim 14 wherein said second subset effects evaluation of said signals of said second communication network for a handover opportunity for the system.

18. A method treating communication signals in a communication environment as recited in claim 15 wherein said second subset effects evaluation of said signals of said second communication network for a handover opportunity for the system.
